(19) United States
(12) Patent Application Publication
(10) Pub. No.: US 2011/0112981 A1
(43) Pub. Date: May 12, 2011

(54) Feature-Based Method and System for Cold-Start Recommendation of Online Ads

(76) Inventors: Seung-Taek Park, San Jose, CA (US); Wei Chu, Santa Clara, CA (US)

(21) Appl. No.: 12/615,058

(22) Filed: Nov. 9, 2009

(51) Int. Cl. G06Q 30/00; G06F 17/30

(52) U.S. Cl. 705/347; 707/705; 707/E17.044

(57) ABSTRACT

A method and a system are provided for recommending an ad (e.g., item) for a user. In one example, the system constructs one or more user profiles. Each user profile is represented by a user feature set including user attributes. The system constructs one or more item profiles. Each item profile is represented by an item feature set including item attributes. The system receives historical item ratings given by one or more users. The system then generates one or more preference scores by modeling at least one relationship among the user profiles, the item profiles and the historical item ratings.

### FIELD OF THE INVENTION

The invention relates to online advertising. More particularly, the invention relates to recommending ads (e.g., item) for online advertising.

### BACKGROUND

Recommender systems automate the familiar social process of friends endorsing products to others in their community. Widely deployed on the web, such systems help users explore their interests in many domains, including movies, music, books, and electronics. Recommender systems are widely applied from independent, community-driven web sites to large e-commerce powerhouses like Amazon.com. Recommender systems can improve users' experiences by personalizing what they see, often leading to greater engagement and loyalty. Merchants, in turn, receive more explicit preference information that paints a clearer picture of their customers. Two different approaches are widely adopted to design recommender systems: content-based filtering and collaborative filtering.

Content-based filtering generates a profile for a user based on the content descriptions of the items previously rated by the user. The major benefit of this approach is that it can recommend users new items, which have not been rated by any users. However, content-based filtering cannot provide recommendations to new users who have no historical ratings. To provide new user recommendation, content-based filtering often asks new users to answer a questionnaire that explicitly states their preferences to generate initial profiles of new users. As a user consumes more items, the users profile is updated and content features of the items that the user consumed will receive more weights. One drawback of content-based filtering is that the recommended items are similar to the items previously consumed by the user. For example, if a user has watched only romance movies, then content-based filtering would recommend only romance movies. It often causes low satisfaction of recommendations due to lack of diversity for new or casual users who may reveal only small fraction of their interests. Another limitation of content-based filtering is that its performance highly depends on the quality of features generation and selection.

On the other hand, collaborative filtering typically associates a user with a group of like-minded users, and then recommends items enjoyed by others in the group. Collaborative filtering has a few merits over content-based filtering. First, collaborative filtering does not require any feature generation and selection method and it can be applied to any domains if user ratings (either explicit or implicit) are available. In other words, collaborative filtering is content-independent. Second, collaborative filtering can provide “serendipitous finding”, whereas content-based filtering cannot. For example, even though a user has watched only romance movies, a comedy movie would be recommended to the user if most other romance movie fans also love it. Collaborative filtering captures this kind of hidden connections between items by analyzing user consumption history (or user ratings on items) over the population. Note that content-based filtering use a profile of individual user but does not exploit profiles of other users.

Collaborative filtering often performs better than content-based filtering when lots of user ratings are available. Unfortunately, collaborative filtering suffers from the cold-start problems where no historical ratings on items or users are available.

### SUMMARY

A key challenge in recommender systems including content-based and collaborative filtering is how to provide recommendations at early stage when available data is extremely sparse. The problem is of course more severe when the system newly launches and most users and items are new. However, the problem never goes away completely. New users and items are constantly coming in any healthy recommender system.

What is needed is an improved method having features for addressing the problems mentioned above and new features not yet discussed. Broadly speaking, the invention fills these needs by providing a method and a system for recommending an item for a user.

In a first embodiment, a computer-implemented method is provided for recommending an item for a user. The method comprises at least the following: constructing, at a computer, one or more user profiles, wherein each user profile is represented by a user feature set including user attributes; constructing, at a computer, one or more item profiles, wherein each item profile is represented by a item feature set including item attributes; receiving, at a computer, historical item ratings given by one or more users; generating, at a computer, one or more affinity scores by modeling the user profiles, the item profiles and the historical item ratings.

In a second embodiment, a system is provided for recommending an item for a user. The server system is configured for at least the following: constructing, at a computer, one or more user profiles, wherein each user profile is represented by a user feature set including user attributes; constructing, at a computer, one or more item profiles, wherein each item profile is represented by a item feature set including item attributes; receiving, at a computer, historical item ratings given by one or more users; generating, at a computer, one or more affinity scores by modeling the user profiles, the item profiles and the historical item ratings.

In a third embodiment, a computer readable medium comprising one or more instructions for recommending an item for a user. The one or more instructions are configured for causing the one or more processors to perform the following steps: constructing, at a computer, one or more user profiles, wherein each user profile is represented by a user feature set including user attributes; constructing, at a computer, one or more item profiles, wherein each item profile is represented by a item feature set including item attributes; receiving, at a computer, historical item ratings given by one or more users; generating, at a computer, one or more affinity scores by modeling the user profiles, the item profiles and the historical item ratings.

The invention encompasses other embodiments configured as set forth above and with other features and alternatives. It should be appreciated that the invention can be implemented in numerous ways, including as a method, a process, an apparatus, a system or a device.

### BRIEF DESCRIPTION OF THE DRAWINGS

The invention will be readily understood by the following detailed description in conjunction with the accompanying drawings. To facilitate this description, like reference numerals designate like structural elements.

FIG. 1 is a high-level block diagram of a system for recommending an ad for a user, in accordance with some embodiments;

FIG. 2 illustrates data partitions in which users and items may be categorized, in accordance with some embodiments;

FIG. 3 is a flowchart of a method for training a model for recommending an ad (e.g., item) for a user, in accordance with some embodiments;

FIG. 4 is a flowchart of a method for serving an item (e.g., ad) to a user, in accordance with some embodiments; and

FIG. 5 is a diagrammatic representation of a network, including nodes that may comprise a machine within which a set of instructions may be executed, in accordance with some embodiments.

### DETAILED DESCRIPTION

An invention is disclosed for a method and a system for recommending an ad (e.g., item) for a user. Numerous specific details are set forth in order to provide a thorough understanding of the invention. It will be understood, however, to one skilled in the art, that the invention may be practiced with other specific details.

### 1. Definitions

Some terms are defined below in alphabetical order for easy reference. These terms are not rigidly restricted to these definitions. A term may be further defined by its use in other sections of this description.

“Ad Server' is a server that is configured for serving one or more ads to user devices. An ad server is preferably controlled by a publisher of a website and/or an advertiser of online ads. A server is defined below.

“Ad” means a paid announcement, as of goods or services for sale, preferably on a network, such as the Internet. An ad may also be referred to as an advertisement, an item.

“Advertiser” means an entity that is in the business of marketing a product and/or a service to users. An advertiser may include without limitation a seller and/or a third-party agent for the seller. An advertiser may also be referred to as a messaging customer.

“Application server” is a server that is configured for running one or more devices loaded on the application server. For example, an application server may be configured for running a device configured for recommending an ad for a user.

“Client” means the client part of a client-server architecture. A client is typically a user device and/or an application that runs on a user device. A client typically relies on a server to perform some operations. For example, an email client is an application that enables a user to send and receive e-mail via an email server. The computer running such an email client may also be referred to as a client.

“User” means an operator of a user device. A user is typically a person who seeks to acquire a product and/or service. For example, a user may be a woman who is browsing Yahoo!™ Shopping for a new cell phone to replace her current cell phone. The term “user” may refer to a user device, depending on the context.

“User device” (e.g., “computer” or “user computer” or “client” or “server”) means a single computer or to a network of interacting computers. A user device is a computer that a user may use to communicate with a data distributor and/or a network, among other things. A user device is a combination of a hardware system, a software operating system and perhaps one or more software application programs. Examples of a user device include without limitation a laptop computer, a palmtop computer, a smart phone, a cell phone, a mobile phone, an IBM-type personal computer (PC) having an operating system such as Microsoft Windows®, an Apple® computer having an operating system such as MAC-OS, hardware having a JAVA-OS operating system, and a Sun Microsystems Workstation having a UNIX operating system.

“Database” means a collection of data organized in such a way that a computer program may quickly select desired pieces of the data. A database is an electronic filing system. In some instances, the term “database” is used as shorthand for “database management system”.

“Device” means hardware, software or a combination thereof. A device may sometimes be referred to as an apparatus. Examples of a device include without limitation a software application such as Microsoft Word®, a laptop computer, a database, a server, a display, a computer mouse, and/or a hard disk.

“Marketplace” means a world of commercial activity where products and/or services are browsed, bought and/or sold. A marketplace may be located over a network, such as the Internet. A marketplace may also be located in a physical environment, such as a shopping mall.

“Network” means a connection, between any two or more computers, that permits the transmission of data. A network may be any combination of networks, including without limitation the Internet, a local area network, a wide area network, a wireless network and a cellular network.

“Publisher” means an entity that publishes, on a network, a web page having content and/or ads.

“Server” means a software application that provides services to other computer programs (and their users), in the same or other computer. A server may also refer to the physical computer that has been set aside to run a specific server application. For example, when the software Apache HTTP Server is used as the web server for a company's website, the computer running Apache is also called the web server. Server applications can be divided among server computers over an extreme range, depending upon the workload.

“Software” means a computer program that is written in a programming language that may be used by one of ordinary skill in the art. The programming language chosen should be compatible with the computer by which the software application is to be executed and, in particular, with the operating system of that computer. Examples of suitable programming languages include without limitation Object Pascal, C, C++ and Java. Further, the functions of some embodiments, when described as a series of steps for a method, could be implemented as a series of software instructions for being operated by a processor, such that the embodiments could be implemented as software, hardware, or a combination thereof. Computer readable media are discussed in more detail in a separate section below.

“System” means a device or multiple coupled devices. A device is defined above.

“Web browser” means any software program which can display text, graphics, or both, from web pages on web sites. Examples of a web browser include without limitation Mozilla Firefox® and Microsoft Internet Explorer®.

“Web page” means any documents written in mark-up language including without limitation HTML (hypertext mark-up language) or VRML (virtual reality modeling language), dynamic HTML, XML (extended mark-up language) or related computer languages thereof, as well as to any collection of such documents reachable through one specific Internet address or at one specific web site, or any document obtainable through a particular URL (Uniform Resource Locator).

“Web server” is a server configured for serving at least one web page to a web browser. An example of a web server is a Yahoo!™ web server. A server is defined above.

“Web site” means at least one web page, and more commonly a plurality of web pages, virtually connected to form a coherent group.

### 2. Overview of Architecture

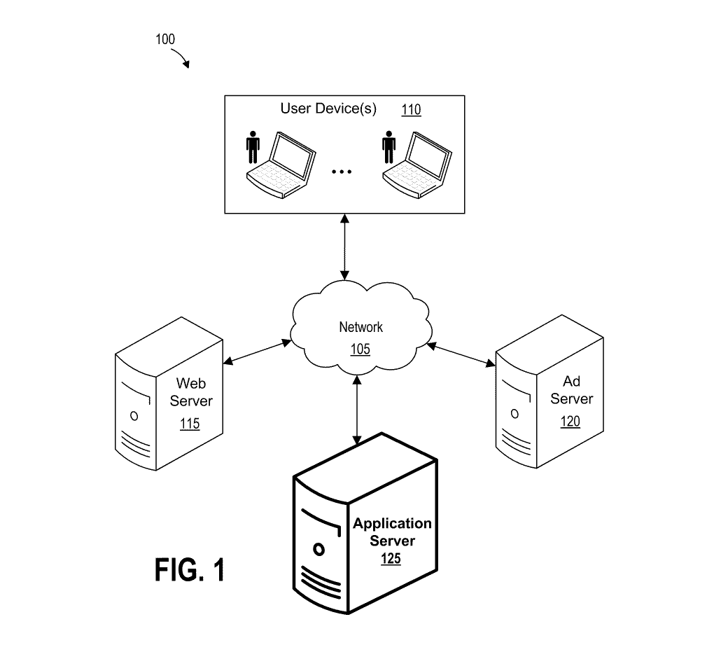

FIG. 1 is a high-level block diagram of a system 100 for recommending an ad for a user, in accordance with some embodiments. The network 105 couples together one or more user devices 110, a web server 115, an ad server 120 and an application server 125. The network 105 may be any combination of networks, including without limitation the Internet, a local area network, a wide area network, a wireless network and/or a cellular network.

Each user device 110 includes without limitation a single computer or a network of interacting computers. Examples of a user device include without limitation a laptop computer, a palmtop computer, a smart phone, a cell phone and a mobile phone. A user communicates over the network 105 by using a user device 110. A user may be, for example, a person browsing or shopping in a marketplace on the Internet.

The application server 125 is a server that is configured for running one or more devices loaded on the application server 125. For example, an application server may be configured for running a device configured for recommending an ad for a user. The application server 125 preferably carries out the more important steps of the system 100 for recommending an ad for a user.

The web server 115 is a server configured for serving at least one web page to a web browser. The web 115 server may also provide user behavior data to the application server 125 and/or the ad server 120 for analyzing purposes. An example of a web server 115 is a Yahoo!™ web server.

The ad server 120 is a server that is configured for serving one or more ads to the user devices 110. The ad server 120 is preferably controlled by a publisher of a website and/or an advertiser of online ads. A publisher is an entity that publishes, on the network 105, a web page having content and/or ads. An advertiser is an entity that is seeking to market a product and/or a service to users at the user devices 110. Examples of a publisher/advertiser 120 include without limitation Yahoo!™, Amazon and Nike.

The configuration of the system 100 in FIG. 1 is for explanatory purposes. There are numerous other configurations in other embodiments that are possible. For example, the ad server 120 and the application 125 may be aggregated into one computing system. As another example, each server may be a system of multiple servers. As still another example, the system 100 may include without limitation a database system (not shown) configured for storing data and coupled to the network 105. There are many other configurations for the system 100 that are feasible as well.

### 3. Introduction to Methodology

As mentioned above, even though collaborative filtering often performs better than content-based filtering when lots of user ratings are available, it suffers from the cold-start problems that occur during a cold-start period. Cold-start problems include having substantially no historical ratings on items or users. A historical rating is a score, defined by one or more users, that indicates the degree to which the one or more users like a product/service. A key challenge in recommender systems including content-based and collaborative filtering is how to provide recommendations at early stage when available data is extremely sparse. The problem is of course more severe when the system newly launches and most users and items are new. However, the problem never goes away completely. New users and items are constantly coming in any healthy recommender system.

The present system is configured to handle at least three types of cold-start setting: (1) recommending existing items for new users, (2) recommending new items for existing users, and (3) recommending new items for new users. There are additional information on users and items often available in real-world recommender systems. The system may request users' preference information by encouraging them to fill in questionnaires or simply collect user-declared demographic information (e.g. age and gender) at registration. The system may also utilize item information by accessing the inventory of most on-line enterpriser. This legally accessible information is valuable for both recommending new items and serving new users. To attack the cold-start problem, the system implements new hybrid approaches which exploit not only user ratings but also user and item features. The system constructs tensor profiles for user/item pairs from their individual features. Within the tensor regression framework, the system optimizes the regression coefficients by minimizing pairwise preference loss. The resulting algorithm scales efficiently as a linear function of the number of observed ratings. The system may be evaluated by using two standard movie data sets: MovieLens and EachMovie. The system preferably does not use movie data sets, like Netflix™ data, that do not provide any user information. Note that one goal is to provide reasonable recommendation to even new users with no historical ratings but only minimal demographic information.

The system is configured for considering a user rating as belonging to one of four partitions. Half of users are new users, and the rest are existing users. Similarly, half of items are new items, and the rest are existing items.

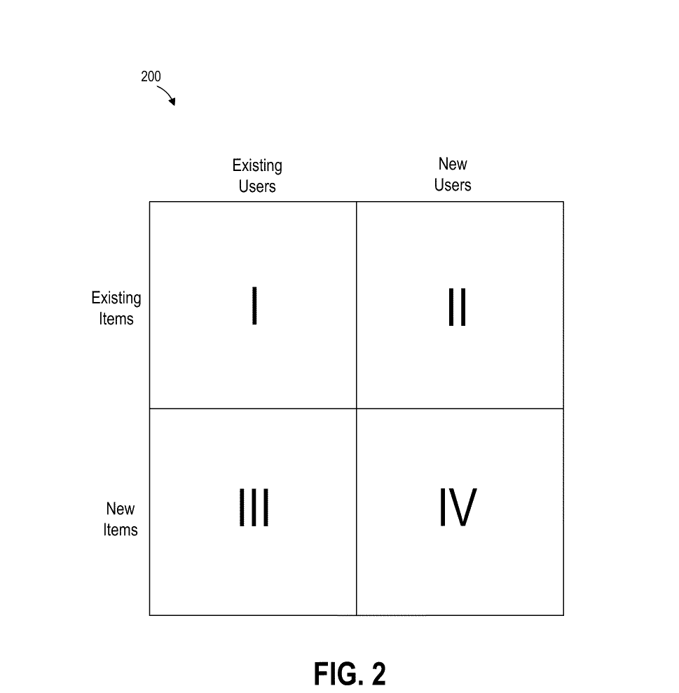

FIG. 2 illustrates data partitions in which users and items may be categorized, in accordance with some embodiments. Partition I (recommendation on existing items for existing users) is the standard case for most traditional collaborative filtering techniques, such as user-user, item based collaborative filtering, singular vector decomposition (SVD), etc. Partition II (recommendation on existing items for new users) is for new users without historical ratings, the “most popular” strategy that recommends the highly-rated items to new users serves as a strong baseline. Partition III (recommendation on new items for existing users) is so that content-based filtering can effectively recommend new items to existing users based on the users' historical ratings and features of items. Partition IV (recommendation on new items for new users) is a hard case, where “Random” strategy is the traditional means of collecting ratings. The present system is preferably directed toward Partition IV, which involves providing recommendations on new items for new users.

### 4. Methodology

In this section, the system is configured to use a regression approach based on profiles for cold-start recommendation. The system may receive information from users who may declare their demographical information, such as age, gender, residence, and etc. Meanwhile, the system may also maintain information of items when items are either created or acquired. Such information may include without limitation product name, service name, company name, manufacturer, genre, production year, etc. An important goal is for the system to build a predictive model for user/item pairs by leveraging all available information of users and items. The predictive model is particularly useful for cold-start recommendation including new user and new item recommendation. In the following, the approach is described in two subsections. Subsection 4.1 presents profile construction, and Subsection 4.2 covers algorithm design.

### 4.1 Profile Construction

It is important to generate and maintain profiles of items of interest for effective cold-start strategies. For example, the system collects item contents (e.g., genre, cast, manufacturer, production year, etc.) as the initial part of the profile for movie recommendation. In addition to these static attributes, the system also estimates items' popularity/quality from available historical ratings in training data, for example, indexed by averaged scores in various user segments, where user segments may be defined by demographical descriptors or advanced conjoint analysis.

Generally, the system may construct user profiles as well by collecting legally usable user-specific features that effectively represent a user's preferences and recent interests. The user features usually consist of demographical information and historical behavior aggregated to some extent.

In this way, each item is represented by a set of features, denoted as a vector z, where z ∈ [symbol] and D is the number of item features. Similarly, each user is represented by a set of user features, denoted as x, where x ∈ [symbol] and C is the number of user features. Note that the system appends a constant feature to the user feature set for all users. A new user with no information is represented as [0, . . . , 0, 1] instead of a vector of zero entries.

Using collaborative filtering (CF), the system may use the ratings given by users on items of interest as user profiles to evaluate commonalities between users. Using a regression approach, the system may separate these feedbacks from user profiles. The system utilizes the ratings as targets that reveal affinities between user features to item features.

Accordingly, the system is configured to collect at least three data sets, including without limitation item profiles (e.g., item attributes/features), user profiles (e.g., user attributes/features) and the historical items ratings given by users. The system indexes the u-th user as xᵤ and the i-th content item as zᵢ, and denotes by rᵤᵢ the interaction between the user xᵤ and the item zᵢ. The system preferably considers interactions on a small subset of all possible user/item pairs, and denotes by [symbol] the index set of observations {rᵤᵢ}.

### 4.2 Regression on Pairwise Preference

A predictive model relates a pair of vectors, xᵤ and zᵢ, to the rating rᵤᵢ on the item zᵢ given by the user xᵤ. There are various ways to construct joint feature space for user/item pairs. The system focuses on the representation via outer products. For example, each pair is represented as xᵤ [symbol] zᵢ, a vector of CD entries {x_{u,a}z_{i,b}} where z_{i,b} denotes the b-th feature of zᵢ and x_{u,a} denotes the a-th feature of xᵤ.

The system defines a parametric indicator as a bilinear function of xᵤ and zᵢ in the following equation:

$${s}_{ui} = {\sum }_{a = 1}^{C} {\sum }_{b = 1}^{D} {x}_{u , a} {z}_{i , b} {w}_{ab} , \qquad Equation 1.$$

C and D are the dimensionality of user and content features, respectively, and a, b are feature indices. The weight variable w_{ab} is independent of user and content features and characterizes the affinity of these two factors x_{u,a} and z_{i,b} in interaction. The indicator can be equivalently rewritten as the following equation:

sᵤᵢ=xᵤWzᵢ^{τ}=w^{τ}(zᵢ [symbol] xᵤ), Equation 2.

W is a matrix containing entries {w_{ab}}, w denotes a column vector stacked from W, and zᵢ [symbol] xᵤ denotes the outer product of xᵤ and zᵢ, a column vector of entries {x_{u,a}z_{i,b}}.

The regression coefficients can be optimized in regularization framework, such as the following equation:

$$arg {min}_{w} {\sum }_{ui ∈ 𝕆} {( {r}_{ui} - {s}_{ui} )}^{2} + λ {‖ w ‖}_{2}^{2} . \qquad Equation 3$$

λ is a tradeoff between empirical error and model complexity. Least squares loss, coupled with 2-norm of w, is widely applied in practice due to computational advantages. The optimal solution of w is unique and has a closed form of matrix manipulation, such as the following equation:

$${w}^{*} = {( {\sum }_{ui ∈ 𝕆} {z}_{i} {z}_{i}^{⊤} ⊗ {x}_{u} {x}_{u}^{⊤} + λ I )}^{- 1} ( {\sum }_{ui ∈ 𝕆} {r}_{ui} {z}_{i} ⊗ {x}_{u} ) . \qquad Equation 4$$

I is CD by CD identity matrix. By exploiting the tensor structure, the matrix preparation costs O(NC²+MC²D²) where M and N are the number of items and users, respectively. The matrix inverse costs O(C³D³), which becomes the most expensive part if M<CD and N<MD².

In recommender systems, users may enjoy different rating criteria. Accordingly, the ratings given by different users are not comparable due to user-specific bias. The system can lessen the effect by introducing a bias term for each user in the above regression formulation. However, the bias term not only enlarges the problem size dramatically from CD to CD+N where N denotes the number of users and usually N>>CD, but also increases uncertainty in the modeling. Another concern is that the least squares loss is favorable for root mean squared error (RMSE) metric but may result in inferior ranking performance. Pairwise loss is typically used for preference learning and ranking for superior performance.

The present system is configured for implementing a personalized pairwise loss in a regression framework. For each user xᵤ, the loss function is generalized as the following equation:

$$\frac{1}{{n}_{u}} {\sum }_{i ∈ {𝕆}_{u}} {\sum }_{j ∈ {𝕆}_{u}} {( ( {r}_{ui} - {r}_{uj} ) - ( {s}_{ui} - {s}_{uj} ) )}^{2} . \qquad Equation 5$$

[symbol] denotes the index set of all items the user xᵤ have rated, nᵤ=| [symbol] | the number of ratings given by the user xᵤ, and sᵤᵢ is defined above in Equation 1. Replacing the squares loss by the personalized pairwise loss in the regularization framework, the system has the following optimization problem:

$${min}_{w} {\sum }_{u} ( \frac{1}{{n}_{u}} {\sum }_{i ∈ {𝕆}_{u}} {\sum }_{j ∈ {𝕆}_{u}} {( ( {r}_{ui} - {r}_{uj} ) - ( {s}_{ui} - {s}_{uj} ) )}^{2} ) + λ {‖ w ‖}_{2}^{2} . \qquad Equation 6$$

u runs over all users. The optimal solution can be computed in a closed form as well, for example, according to the following equations:

$$\begin{matrix}{w}^{*} = {( A + \frac{λ}{2} I )}^{- 1} B . & Equation 7 \\ A = {\sum }_{u} {\sum }_{i ∈ {𝕆}_{u}} {{z}_{i} ( {z}_{i} - {\tilde{z}}_{u} )}^{⊤} ⊗ {x}_{u} {x}_{u}^{⊤} . & Equation 8 \\ B = {\sum }_{u} {\sum }_{i ∈ {𝕆}_{u}} {r}_{ui} ( {z}_{i} - {\tilde{z}}_{u} ) ⊗ {x}_{u} . & Equation 9 \\ {\tilde{z}}_{u} = \frac{1}{{n}_{u}} {\sum }_{i ∈ {𝕆}_{u}} {z}_{i} . & Equation 10\end{matrix}$$

The size in matrix inverse is still CD and the matrix preparation costs O(NC²+MC²D²) same as that of the least squares loss.

When matrix inversion with very large CD becomes computationally prohibitive, the system can instead apply gradient-descent techniques for a solution. The gradient can be evaluated by Aw−B. There is no matrix inversion involved in each evaluation, and the most expensive step inside is to construct the matrix A once only. Usually it would take hundreds of iterations for a gradient-descent package to get close to the minimum. Note that this is a convex optimization problem with a unique solution at a minimum.

### 5. Overview of Method for Training a Model for Recommending an Ad for a User

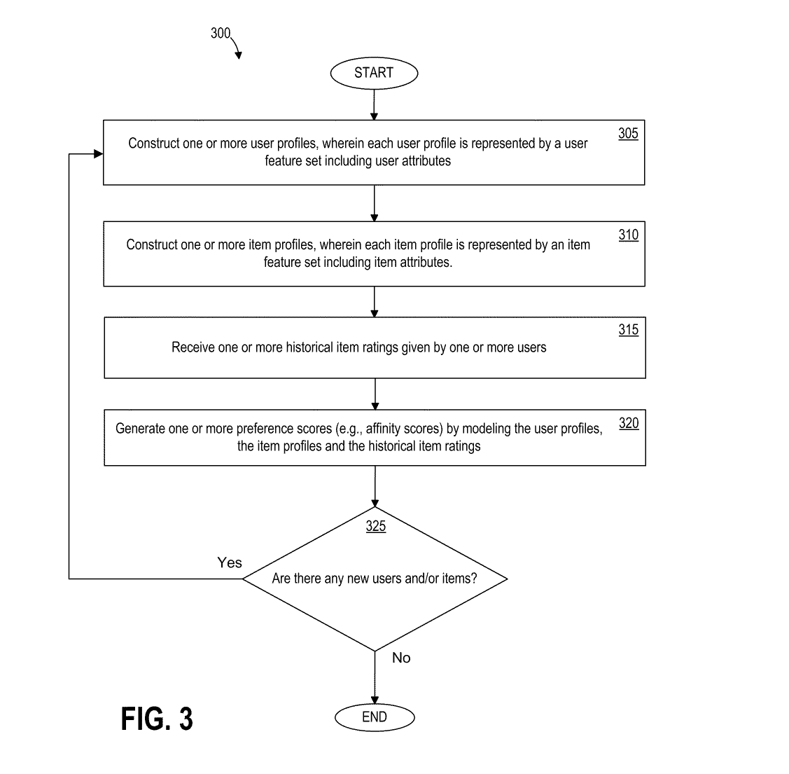

FIG. 3 is a flowchart of a method 300 for training a model for recommending an ad (e.g., item) for a user, in accordance with some embodiments. The steps of the method 300 may be carried out by one or more devices of the system 100 of FIG. 1.

The method 300 starts in a step 305 where the system constructs one or more user profiles. Each user profile is represented by a user feature set including user attributes. The user attributes are data about one or more users. For example, user attributes may include user inputted data including without limitation demographic information, such as age, gender, residence, etc. User profile construction is discussed in more detail above in Subsection 4.1.

The method 300 then moves to a step 310 where the system constructs one or more item profiles. Each item profile is represented by an item feature set including item attributes. The item attributes are data about one or more items that are subjects of ads. For example, item attributes may include without limitation product name, service name, company name, manufacturer, genre, production year, etc. Item profile construction is discussed in more detail above in Subsection 4.1.

Next, in a step 315, the system receives one or more historical item ratings given by one or more users. A historical rating is a score, defined by one or more users, that indicates the degree to which one or more users like an item (e.g., product and/or service). The historical item ratings may be used to estimate popularity/quality of the one or more items. For example, historical item ratings may be indexed by averaged ratings (e.g., scores) in various user segments, where user segments may be defined by demographical descriptors or advanced conjoint analysis. Historical item ratings are discussed in more detail above in Subsection 4.1.

The method 300 then proceeds to a step 320 where the system generates one or more preference scores (e.g., affinity scores) by modeling the user profiles, the item profiles and the historical ratings. Modeling includes comprehensively comparing one or more combinations of the user feature sets, the item feature sets and the historical ratings. This modeling utilizes pairwise preference, which is discussed in more detail above in Subsection 4.2.

Next, in a decision operation 330, the system determines if there are any news users and/or ads. If the system determines that there are new users and/or ads, then the system returns to the step 305 where the system receives attributes. However, if the system determines in the decision operation 330 that there are no new users and/or ads, then the method 300 concludes.

Note that the method 300 may include other details and steps that are not discussed in this method overview. Other details and steps are discussed with reference to the appropriate figures and may be a part of the method 300, depending on the embodiment.

### 6. Overview of Method for Serving an Ad to a User

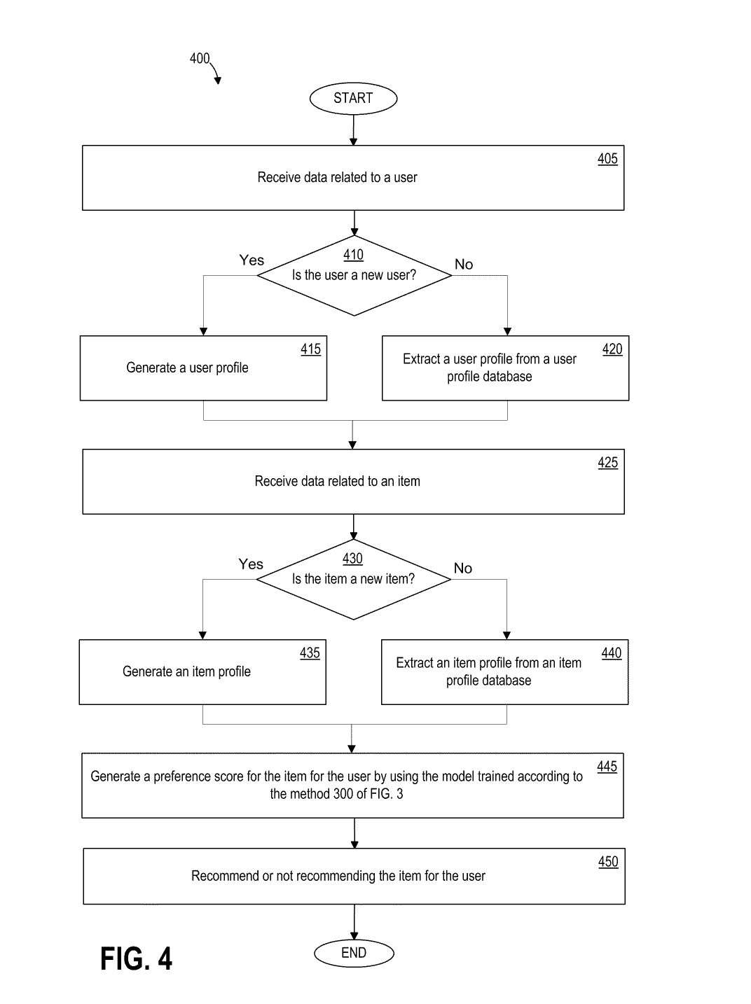

FIG. 4 is a flowchart of a method 400 for serving an item (e.g., ad) to a user, in accordance with some embodiments. The steps of the method 400 may be carried out by one or more devices of the system 100 of FIG. 1.

The method 400 starts in a step 405 where the system receives data related to a user. The method 400 then moves to a decision operation 410 where the system determines if the user is a new user. If the system determines the user is a new user, then the method 400 proceeds to a step 415 where the system generates a user profile from the user. For example, user attributes may include user inputted data including without limitation demographic information, such as age, gender, residence, etc. User profile construction is discussed in more detail above in Subsection 4.1. However, if the system determines in the decision operation 410 that the user is not a new user, then the method 400 proceeds to a step 420 where the system extracts a user profile from a user profile database.

The method 400 then moves to a step 425 where the system receives data related to an item. The method 400 then moves to a decision operation 430 where the system determines if the item is a new item. If the system determines the user is a new item, then the method 400 proceeds to a step 435 where the system generates an item profile from the item. For example, item attributes may include without limitation product name, service name, company name, manufacturer, genre, production year, etc. Item profile construction is discussed in more detail above in Subsection 4.1. However, if the system determines in the decision operation 430 that the item is not a new item, then the method 400 proceeds to a step 440 where the system extracts an item profile from an item profile database.

The method 400 then moves to a step 445 where the system generates a preference score (e.g., affinity score) for the item for the user by using the model trained according to the method 300 of FIG. 3. Next, in a step 450, the system recommends or does not recommend the item for the user. If the system recommends more than one item for the user, then the system preferably recommends a few items having the highest preference scores for the user.

Note that the method 400 may include other details and steps that are not discussed in this method overview. Other details and steps are discussed with reference to the appropriate figures and may be a part of the method 400, depending on the embodiment.

### 7. Exemplary Network, Client, Server and Computer Environments

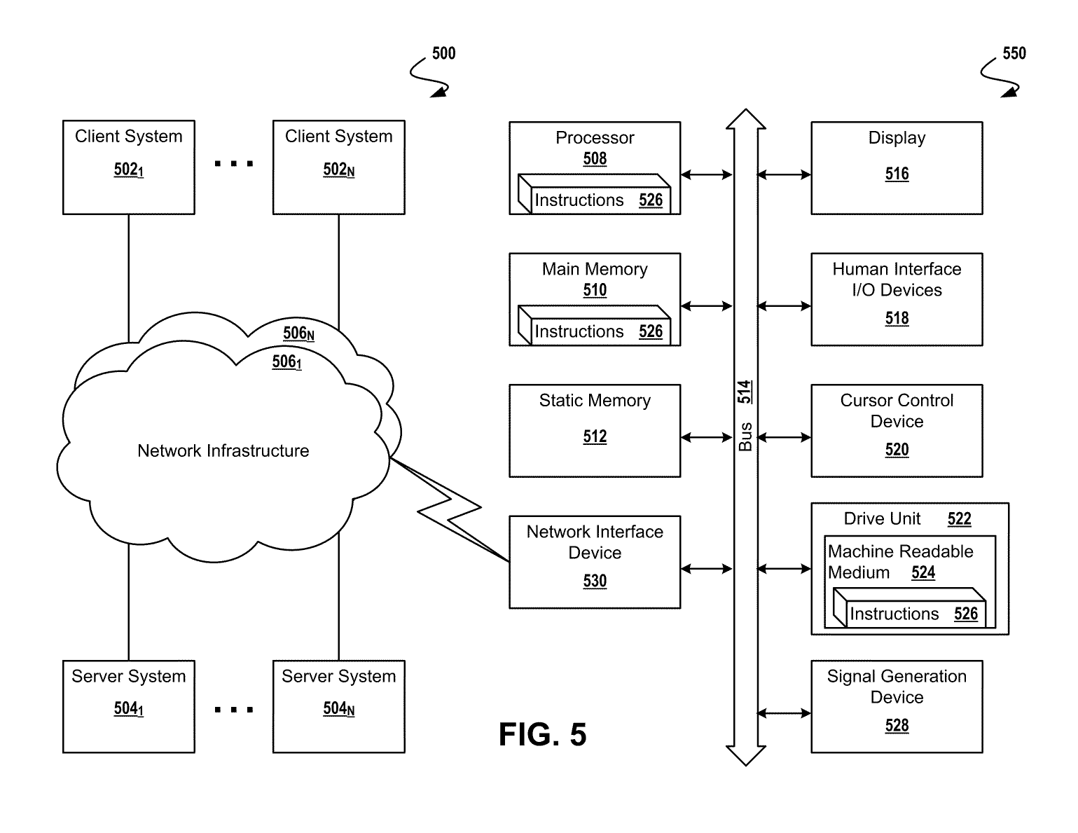

FIG. 5 is a diagrammatic representation of a network 500, including nodes for client systems 502₁ through 502_{N}, nodes for server systems 504₁ through 504_{N}, nodes for network infrastructure 506₁ through 506_{N}, any of which nodes may comprise a machine 550 within which a set of instructions, for causing the machine to perform any one of the techniques discussed above, may be executed. The embodiment shown is exemplary, and may be implemented in the context of one or more of the figures herein.

Any node of the network 500 may comprise a general-purpose processor, a digital signal processor (DSP), an application specific integrated circuit (ASIC), a field programmable gate array (FPGA) or other programmable logic device, discrete gate or transistor logic, discrete hardware components, or any combination thereof capable to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration, etc).

In alternative embodiments, a node may comprise a machine in the form of a virtual machine (VM), a virtual server, a virtual client, a virtual desktop, a virtual volume, a network router, a network switch, a network bridge, a personal digital assistant (PDA), a cellular telephone, a web appliance, or any machine capable of executing a sequence of instructions that specify actions to be taken by that machine. Any node of the network may communicate cooperatively with another node on the network. In some embodiments, any node of the network may communicate cooperatively with every other node of the network. Further, any node or group of nodes on the network may comprise one or more computer systems (e.g., a client computer system, a server computer system) and/or may comprise one or more embedded computer systems, a massively parallel computer system, and/or a cloud computer system.

The computer system 550 includes a processor 508 (e.g., a processor core, a microprocessor, a computing device, etc.), a main memory 510 and a static memory 512, which communicate with each other via a bus 514. The machine 550 may further include a display unit 516 that may comprise a touch-screen, or a liquid crystal display (LCD), or a light emitting diode (LED) display, or a cathode ray tube (CRT). As shown, the computer system 550 also includes a human input/output (I/O) device 518 (e.g. a keyboard, an alphanumeric keypad, etc), a pointing device 520 (e.g., a mouse, a touch screen, etc), a drive unit 522 (e.g., a disk drive unit, a CD/DVD drive, a tangible computer readable removable media drive, an SSD storage device, etc.), a signal generation device 528 (e.g., a speaker, an audio output, etc.), and a network interface device 530 (e.g., an Ethernet interface, a wired network interface, a wireless network interface, a propagated signal interface, etc.).

The drive unit 522 includes a machine-readable medium 524 on which is stored a set of instructions 526 (e.g., software, firmware, middleware, etc.) embodying any one, or all, of the methodologies described above. The set of instructions 526 is also shown to reside, completely or at least partially, within the main memory 510 and/or within the processor 508. The set of instructions 526 may further be transmitted or received via the network interface device 530 over the network bus 514.

It is to be understood that embodiments of this invention may be used as, or to support, a set of instructions executed upon some form of processing core (such as the CPU of a computer) or otherwise implemented or realized upon or within a machine- or computer-readable medium. A machine-readable medium includes any mechanism for storing or transmitting information in a form readable by a machine (e.g., a computer). For example, a machine-readable medium includes read-only memory (ROM); random access memory (RAM); magnetic disk storage media; optical storage media; flash memory devices; electrical, optical or acoustical or any other type of media suitable for storing information.

### 8. Advantages

In many real recommender systems, great portion of users are new users and converting new users to active users is a key of success for online enterprisers. The present system implements hybrid approaches that exploit not only user ratings but also features of users and items for cold-start recommendation. The system constructs profiles for user/item pairs by outer product over their individual features, and builds predictive models in a regression framework on pairwise user preferences. A unique solution is found by solving a convex optimization problem, and the resulting algorithms of the modeling scale efficiently for relatively large-scale data sets (e.g., feature sets).

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

What is claimed is:

1. A computer-implemented method for recommending an item for a user, the method comprising:
constructing, at a computer, one or more user profiles, wherein each user profile is represented by a user feature set including user attributes;
constructing, at a computer, one or more item profiles, wherein each item profile is represented by a item feature set including item attributes;
receiving, at a computer, historical item ratings given by one or more users;
generating, at a computer, one or more preference scores by modeling at least one relationship among the user profiles, the item profiles and the historical item ratings.

2. The method of claim 1, further comprising providing, at a computer, at least one item recommendation based on the one or more preference scores.

3. The method of claim 1, wherein each user feature set is denoted as a user vector, and wherein each item feature set is denoted by an item vector.

4. The method of claim 1, wherein each historical item rating is at least one of:
used to estimate popularity of one or more items described by the item profiles;
indexed by averaged ratings in various user segments; and
a personal preference score given by an individual user.

5. The method of claim 1, wherein modeling includes comprehensively comparing one or more combinations of the user feature sets, the item feature sets and the historical ratings.

6. The method of claim 1, wherein generating one or more preference scores includes utilizing predictive models in a regression framework on pairwise user preferences.

7. The method of claim 1, wherein the method is carried out during a cold-start time period, and wherein users described by the user profiles are new users that are not associated with historical ratings of items.

8. The method of claim 1, wherein the method is carried out during a cold-start time period, and wherein items described by the item profiles are new items that are not associated with historical ratings of items.

9. The method of claim 6, wherein the modeling includes one or more algorithms for generating the preference scores, and wherein the algorithms scale efficiently for relatively large-scale feature sets.

10. The method of claim 1, further comprising at least one of:
determining, at a computer, if a user is a new user;
generating, at a computer, a user profile;
extracting a user profile from a user profile database;
determining, at a computer, if an item is a new item;
generating, at a computer, an item profile;
extracting an item profile from an item profile database;
generating a preference score for the item; and
recommending one or more items for the user.

11. A system for training a model for recommending an item for a user, the system comprising:
a computer system configured for:
constructing one or more user profiles, wherein each user profile is represented by a user feature set including user attributes;
constructing one or more item profiles, wherein each item profile is represented by a item feature set including item attributes;
receiving historical item ratings given by one or more users;
generating one or more preference scores by modeling at least one relationship among the user profiles, the item profiles and the historical item ratings.

12. The system of claim 11, wherein the computer system is further configured for providing at least one item recommendation based on the one or more preference scores.

13. The system of claim 11, wherein each user feature set is denoted as a user vector, and wherein each item feature set is denoted by an item vector.

14. The system of claim 11, wherein each historical item rating is at least one of:
used to estimate popularity of one or more items described by the item profiles;
indexed by averaged ratings in various user segments; and
a personal preference score given by an individual user.

15. The system of claim 11, wherein modeling includes comprehensively comparing one or more combinations of the user feature sets, the item feature sets and the historical ratings.

16. The system of claim 11, wherein generating one or more preference scores includes utilizing predictive models in a regression framework on pairwise user preferences.

17. The system of claim 11, wherein the system is configured to be operated during a cold-start time period, and wherein users described by the user profiles are new users that are not associated with historical ratings of items.

18. The system of claim 11, wherein the system is configured to be operated during a cold-start time period, and wherein items described by the item profiles are new items that are not associated with historical ratings of items.

19. The system of claim 16, wherein the modeling includes one or more algorithms for generating the preference scores, and wherein the algorithms scale efficiently for relatively large-scale feature sets.

20. The system of claim 11, wherein the computer system is further configured for at least one of:
determining, at a computer, if a user is a new user;
generating, at a computer, a user profile;
extracting a user profile from a user profile database;
determining, at a computer, if an item is a new item;
generating, at a computer, an item profile;
extracting an item profile from an item profile database;
generating a preference score for the item; and
recommending one or more items for the user.

21. A computer readable medium comprising one or more instructions for recommending an item for a user, wherein the one or more instructions are configured for causing the one or more processors to perform the steps of:
constructing one or more user profiles, wherein each user profile is represented by a user feature set including user attributes;
constructing one or more item profiles, wherein each item profile is represented by a item feature set including item attributes;
receiving historical item ratings given by one or more users;
generating one or more preference scores by modeling the user profiles, the item profiles and the historical item ratings.
